(19) United States
(12) Patent Application Publication
(10) Pub. No.: US 2014/0044045 A1
(43) Pub. Date: Feb. 13, 2014

(54) STRUCTURE OF TVWS OFDM PHY FRAME

(71) Applicant: Electronics and Telecommunications Research Institute, Daejeon-si (KR)

(72) Inventor: Cheol Ho SHIN, Daejeon-si (KR)

(73) Assignee: Electronics and Telecommunications Research Institute, Daejeon-si (KR)

(21) Appl. No.: 13/964,832

(22) Filed: Aug. 12, 2013

(30) Foreign Application Priority Data
Aug. 10, 2012 (KR) 10-2012-0087609
Aug. 9, 2013 (KR) 10-2013-0094928

(51) Int. Cl. H04W 28/06

(52) U.S. Cl. CPC H04W 28/065
USPC 370/328

(57) ABSTRACT

The present invention relates to the structure of a frame which can be used as the Orthogonal Frequency Division Multiplexing (OFDM) physical (PHY) standard of TV White Spaces (TVWS). In accordance with the present invention, the throughput of an OFDM system can be improved by providing the TVWS OFDM PHY structure that supports efficient data transfer, and the wide selection of a scrambling seed can be guaranteed because a scrambling seed value is included in the PHY header.

Priority to Korean patent applications No. 10-2012-0087609 filed on Aug. 10, 2012, and No. 10-2013-0094928 filed on Aug. 9, 2013, the entire disclosure of which is incorporated by reference herein, is claimed.

### BACKGROUND OF THE INVENTION

1. Field of the Invention

The present invention relates to wireless communication and, more particularly, to the structure of a frame which can be used as an Orthogonal Frequency Division Multiplexing (OFDM) physical (PHY) standard of TV White Spaces (TVWS).

2. Discussion of the Related Art

Available frequency bands are almost extremely congested due to various types of suddenly developing wireless communication technology. As one of methods for solving the shortage problem of the radio resources, a scheme using White Spaces (WS), that is, frequency resources not used by existing users, is being taken into consideration. Recently, a scheme for providing new service, such as super Wi-Fi that uses TVWS, that is, an unused frequency band for TV broadcasting, is being taken into consideration. In particular, the Federal Communications Commission (FCC) has passed a bill on which WSs, that is, unused TV frequency bands, are available for use in November, 2008.

Meanwhile, in the Institute of Electrical and Electronics Engineers (IEEE) 802.15.4m, a Wireless Personal Area Network (WPAN) PHY layer using TVWS is being standardized since September, 2011, and many related techniques are being developed. In this standard and the conventional techniques, a data transfer rate is substantially limited because the number of Short Training Field (STF) OFDM symbols that form the STF of OFDM PHY is fixed, and only a limited number of scrambling seeds can be used through scrambler indices because of a limited number of bits that form an existing PHY header.

For example, Korean Patent Laid-Open Publication No. 10-2011-0002776 entitled “Method of communicating for smart utility network using TV white space and apparatus for the same” discloses that an STF OFDM symbol consisting of 160 samples is configured by repeatedly using an STF sequence having 16 repetition cycles in order to expand a range in which frequency synchronization is obtained in configuring the STF of an OFDM transfer scheme formed of 128 Inverse Fast Fourier Transform (128IFFT).

For another example, U.S. Patent Laid-Open Publication No. US20110051706A1 entitled “Wireless network system” discloses that a repetition sign of the last one or more STF sequences that form the last STF is inversed while configuring an STF using 4 STF OFDM symbols in configuring the preamble of an OFDM transfer scheme.

For yet another example, U.S. Patent Laid-Open Publication No. US2011317779A1 entitled “Scrambling sequences for wireless networks” discloses that scrambler indices each having 2 bits are allocated to a PHY header and four 9-bit scrambling seed values are used using two of the scrambler indices allocated to the PHY header in order to define a scrambling seed value capable of initializing a Pseudo Noise (PN) 9 scrambler. Here, PN9 can be called pseudo-random transmission.

The conventional methods are problematic in that a substantial data transfer rate is reduced because STF OFDM symbols that form an STF necessary to restore packet information not related to real data are excessively allocated even if a packet for transmitting a very small amount of data is configured and only a limited number of scrambling seed values associated with scrambler indices are used in order to reduce the amount of information included in the PHY header.

### SUMMARY OF THE INVENTION

An object of the present invention is to provide the structure of an OFDM PHY frame for supporting efficient data transfer.

Another object of the present invention is to provide a variable STF structure for improving the throughput of an OFDM system.

Yet another object of the present invention is to provide the structure of a PHY header including a scrambling seed value.

In accordance with an aspect of the present invention, there is provided a communication method using TVWS. The method includes generating one or more STF OFDM symbols that form the STF of WPAN OFDM PHY using TVWS and generating a PPDU by variably allocating the number of generated STF OFDM symbols.

In accordance with another aspect of the present invention, there is provided a communication apparatus using TVWS. The communication apparatus includes an OFDM symbol generator for generating one or more STF OFDM symbols that form the STF of WPAN OFDM PHY using TVWS and a PPDU generator for generating a PPDU by variably allocating the number of generated STF OFDM symbols.

In accordance with yet another aspect of the present invention, there is provided a communication method using TVWS in a WPAN system using TVWS. The communication method includes generating a PHY header including a scrambling seed field regarding a PN 9 scrambler and generating a PPDU including the PHY header.

In accordance with further yet another aspect of the present invention, there is provided a communication apparatus using TVWS. The communication apparatus includes a PHY header generator for generating a PHY header including a scrambling seed field regarding a PN 9 scrambler and a PPDU generator for generating a PLCP PPDU including the PHY header.

### BRIEF DESCRIPTION OF THE DRAWINGS

FIG. 1 shows a TVWS OFDM PHY channel allocation scheme in accordance with an embodiment of the present invention;

FIG. 2 shows a basic construction for TVWS OFDM and available data transfer rate modes in accordance with an embodiment of the present invention;

FIG. 3 shows the construction of a Multi-Rate and Multi-Regional Orthogonal Frequency Division Multiplexing (MR-OFDM) PLCP Protocol Data Unit (PPDU);

FIG. 4 shows an STF OFDM symbol in accordance with an embodiment of the present invention;

FIG. 5 shows the construction of an OFDM PHY PPDU in accordance with an embodiment of the present invention;

FIG. 6 shows the construction of an MR-OFDM PHY header;

FIG. 7 shows an example of four types of scrambling seed values each having 9 bits for a PN9 scrambler corresponding to an existing scrambler index of 2 bits;

FIG. 8 shows the construction of a TVWS OFDM PHY header that includes a scrambling seed value of 9 bits for PN9 in a PHY header in accordance with the present invention;

FIG. 9 is a flowchart illustrating a communication method using TVWS in accordance with an example of the present invention;

FIG. 10 is a flowchart illustrating a communication method using TVWS in accordance with another example of the present invention; and

FIG. 11 is a block diagram of a communication apparatus using TVWS in accordance with the present invention.

### DETAILED DESCRIPTION OF THE EMBODIMENTS

Hereinafter, in this specification, some exemplary embodiments of the present invention will be described in detail with reference to the accompanying drawings. It is to be noted that in assigning reference numerals to elements in the drawings, the same reference numerals denote the same elements throughout the drawings even in cases where the elements are shown in different drawings. Furthermore, in describing the embodiments of the present invention, a detailed description of the known functions and constitutions will be omitted if it is deemed to make the gist of the present invention unnecessarily vague.

Furthermore, in describing the elements of this specification, terms, such as the first, the second, A, B, (a), and (b), may be used. However, although the terms are used only to distinguish one element from the other element, the essence, order, or sequence of the elements is not limited by the terms. When it is said that one element is ‘connected’, ‘combined’, or ‘coupled’ with the other element, the one element may be directly connected or coupled with the other element, but it should also be understood that a third element may be ‘connected’, ‘combined’, or ‘coupled’ between the two elements.

The present invention proposes a WPAN PHY layer structure for sensing using TVWS and control applications. The present invention proposes a scheme for configuring an STF packet, which can reduce the time that it is taken to send additional information due to the allocation of excessive STFs for synchronization in addition to the transmission of real data when configuring a packet on which a small amount of data is transmitted. Furthermore, the present invention propose a scheme for configuring a PHY header, which can send a scrambling seed value itself within information about the PHY header by taking a TVWS OFDM characteristic capable of providing a sufficient large number of bits of the PHY header into consideration, instead of using a method for allocating a scrambler index to an existing PHY header and using a limited number of scrambling seeds associated with the scrambler index, in order to reduce the amount of information included in the PHY header.

To this end, in the present invention, an STF OFDM symbol consisting of 160 samples is configured by repeating an STF sequence having a repetition cycle of 16 samples ten times. Furthermore, in order to bring out advantages of 10 STF sequences included in one OFDM symbol, the number of STF OFDM symbols is adaptively allocated according to an application purpose of a system designer unlike in an existing scheme in which the number of STF OFDM symbols is fixed. For example, in an application that requires synchronization performance, a large number of STF OFDM symbols can be allocated. For another example, in an application in which the throughput of a real data transfer rate needs to be improved, a small number of STF OFDM symbols can be applied. More particularly, for example, 1 to 4 STF OFDM symbols can be variably set.

Furthermore, a PHY header for TVWS OFDM is designed to provide a relatively high data transfer rate in a WPAN using the excellent propagation characteristics of TVWS. That is, the PHY header supports a structure in which a sufficient amount of data can be transmitted per OFDM symbol in data transfer mode. In this specification, a problem in which only a limitedly fixed scrambling seed value indicated by a scrambler index is transmitted can be overcome by transmitting a scrambling seed value itself within a PHY header.

Some examples of the present invention are described in detail below with reference to the accompanying drawings.

1. Method of Configuring an STF for TVWS OFDM PHY

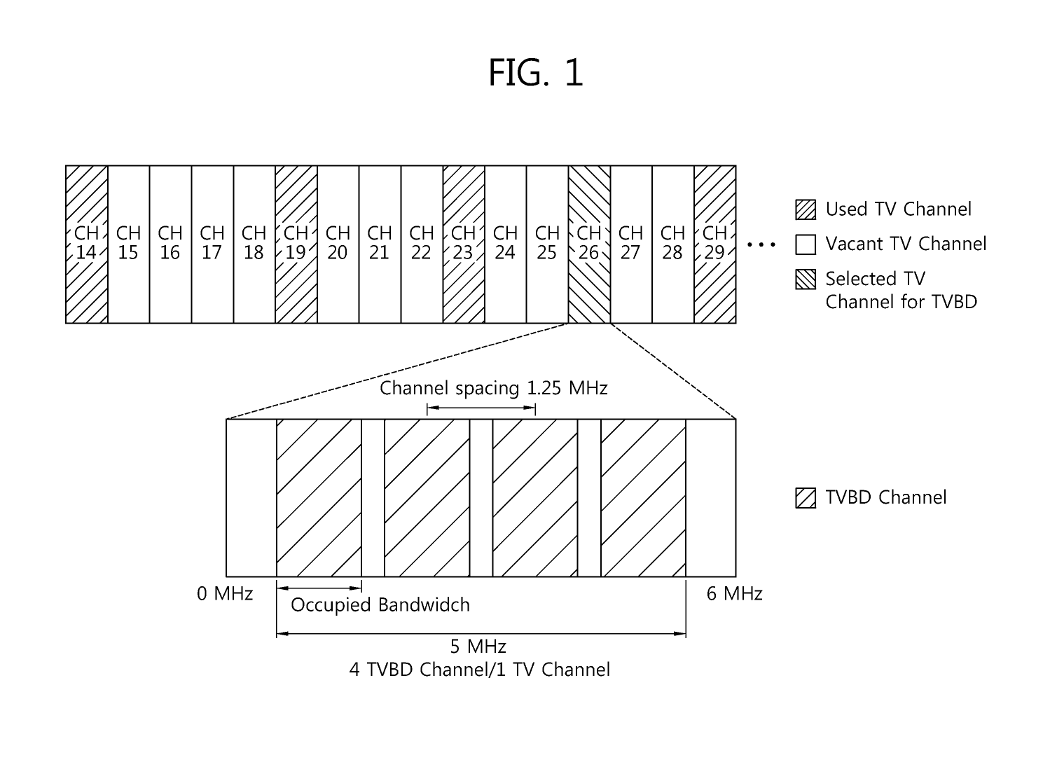

FIG. 1 shows a TVWS OFDM PHY channel allocation scheme in accordance with an embodiment of the present invention. FIG. 1 is a TVWS OFDM PHY channel allocation scheme that is being taken into consideration in IEEE802.14.4m.

Referring to FIG. 1, at least one of vacant TV channels can be selected as a TV channel for allocating a TV Band Device (TVBD) channel. A plurality of TVBD channels (e.g., 4) can be allocated to the TV channel band (e.g., CH 26) selected for the TVBD channel allocation.

The vacant TV channel can be called a TVWS. For example, the TVWS may be included in a band of 512 MHz to 698 MHz or may be included in a UHF channel 21 to a channel 51 (except a channel 37 of 608 to 614 MHz).

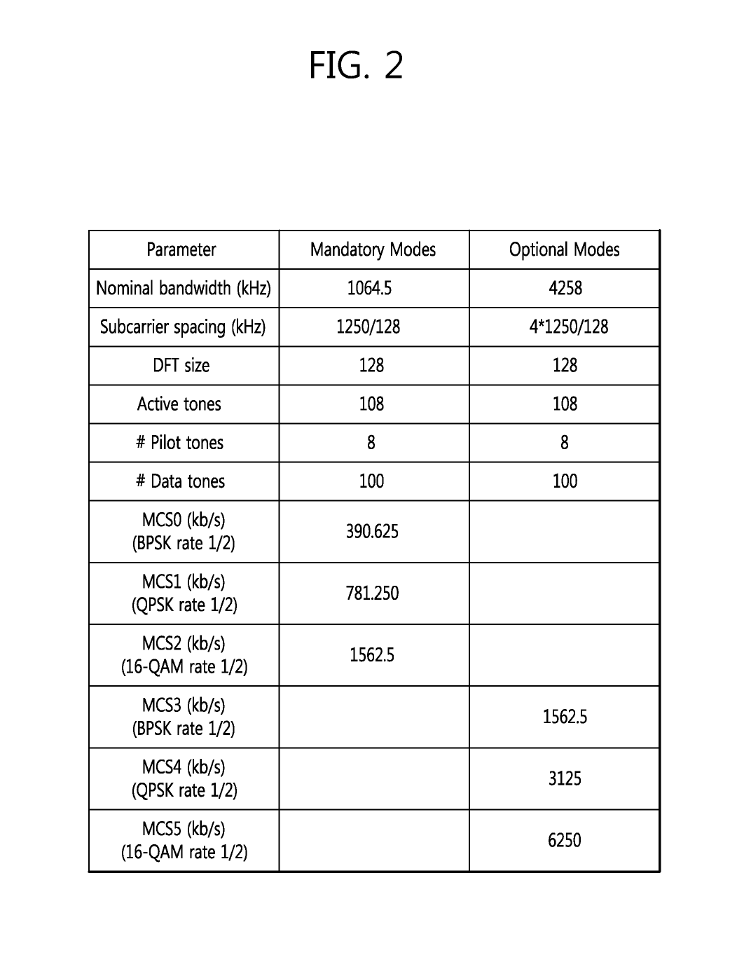

FIG. 2 shows a basic construction for TVWS OFDM and available data transfer rate modes in accordance with an embodiment of the present invention.

Referring to FIG. 2, there are several transfer modes for TVWS OFDM PHY in which information about a PHY header is transmitted. From among the transfer modes, the lowest transfer mode can be a BPSK mode having an encoding rate of ½. The number of data tones capable of sending data for TVWS OFDM PHY is 100. If the lowest data transfer rate of TVWS OFDM PHY is used, the amount of data that can be transmitted through one OFDM symbol is 50 bits. If the highest data transfer rate is used, the amount of data of 200 bits can be transmitted through one OFDM symbol. A real data transfer rate necessary for sensing and control that are main application fields of TVWS WPAN are estimated to be within 100 bytes. If the 100 bytes (i.e., 800 bits) are transmitted using the highest data transfer rate of TVWS OFDM PHY, only four OFDM symbols are necessary.

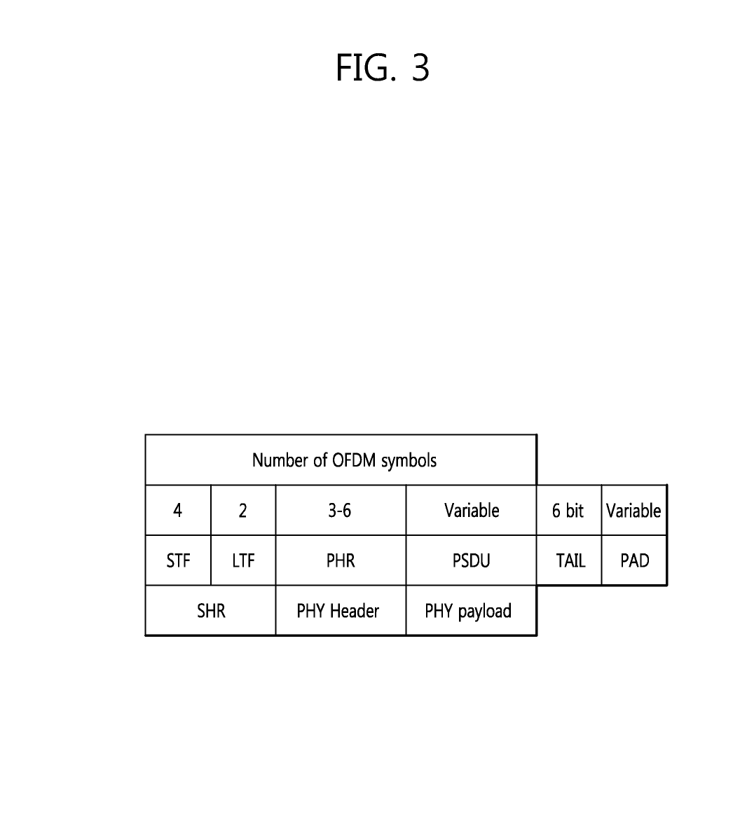

FIG. 3 shows the construction of a Multi-Rate and Multi-Regional Orthogonal Frequency Division Multiplexing (MR-OFDM) PLCP Protocol Data Unit (PPDU). FIG. 3 shows the construction of the PPDU of the MR-OFDM PHY header that is being standardized in IEEE802.15.4g.

Referring to FIG. 3, in the MR-OFDM PHY header of IEEE802.15.4.g, an STF includes 4 STF OFDM symbols. If this STF is applied to TVWS OFDM, the number of STF OFDM symbols necessary to send 100 bytes (800 bits) becomes 4 that is the same as that of the number of OFDM symbols necessary to send real data using the highest data transfer rate mode of TVWS OFDM PHY. It may result in a severe reduction in the throughput of real data transmission. In order to reduce the reduction of the throughput, there is a need for a new TVWS OFDM PHY structure.

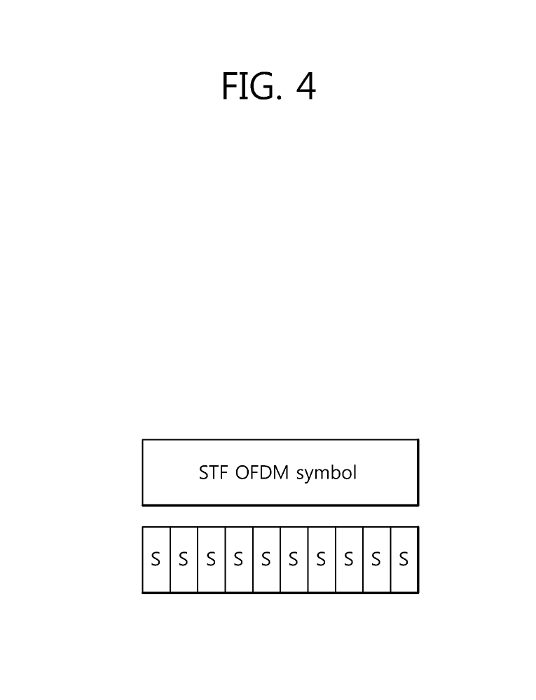

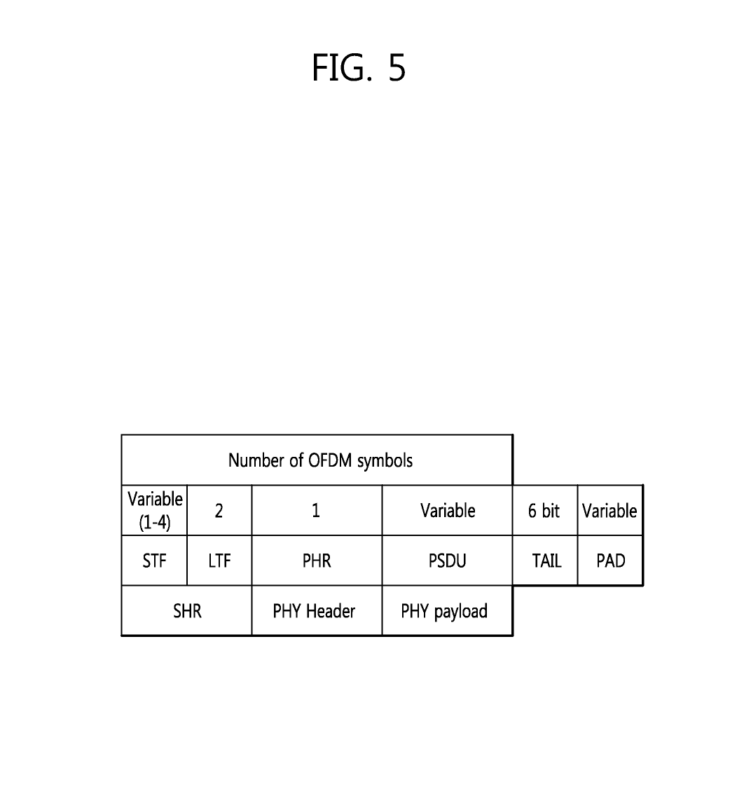

FIG. 4 shows an STF OFDM symbol in accordance with an embodiment of the present invention, and FIG. 5 shows the construction of an OFDM PHY PPDU in accordance with an embodiment of the present invention.

In order to reduce the reduction of the throughput, in TVWS OFDM PHY, an STF sequence having a repetition cycle per 16 samples is repeated ten times as in FIG. 4. In this case, an STF OFDM symbol can include a total of 160 samples. In order to take advantages of the 10 STF sequences included in one STF OFDM symbol, the number of STF symbols that form the STF as in FIG. 5 can vary from 1 to 4 depending on the application without fixing the number of STF OFDM symbols that form the STF as in the prior art. In this case, a real system throughput can be improved along with a PHY standard on which one TVWS OFDM PHY header symbol can be transmitted.

2. Structure of PHY Header Including Scrambling Seed

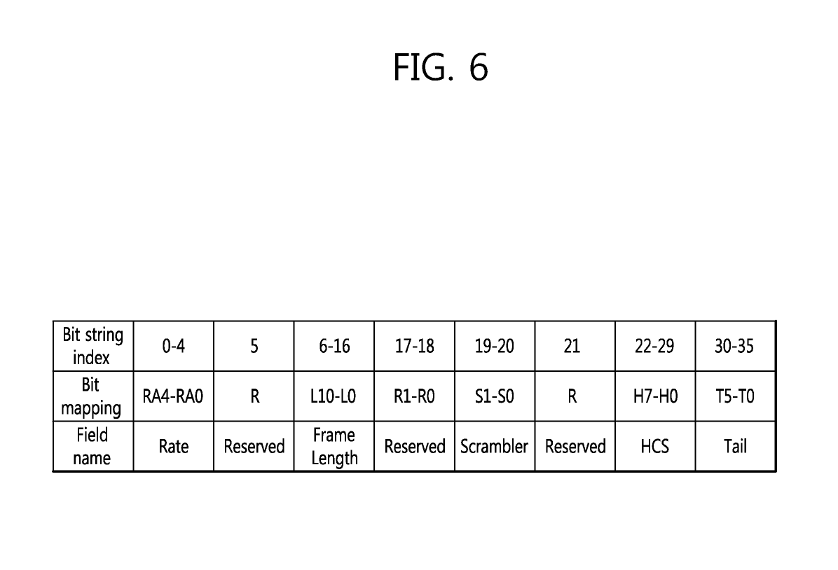

FIG. 6 shows the construction of an MR-OFDM PHY header. FIG. 6 shows the structure of the MR-OFDM PHY header for the IEEE802.15.4g SUN (Smart Utility Network).

Referring to FIG. 6, a scrambling seed for initializing a scrambler is indicated by a scrambler index, and the scrambler index is allocated to the bit string indices 19 and 20, that is, 2 bits, of the PHY header.

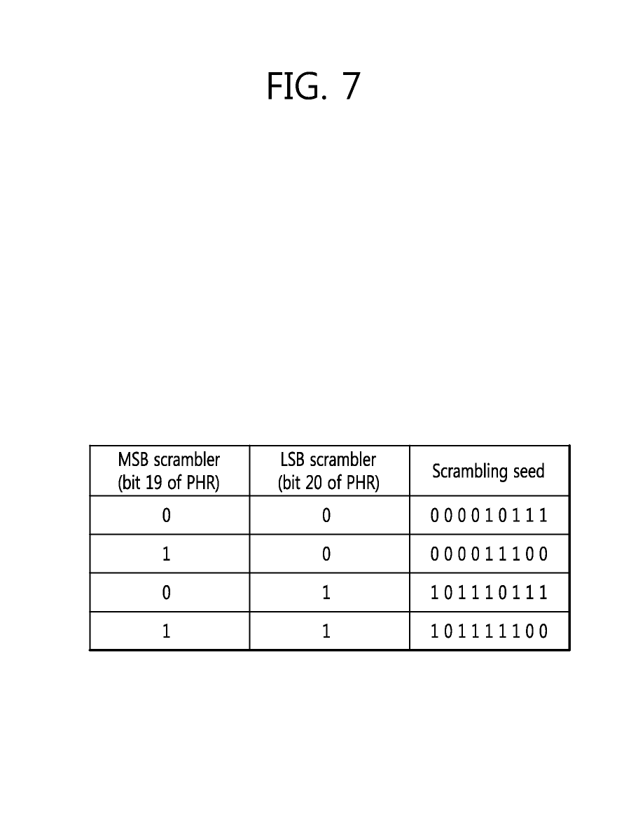

FIG. 7 shows an example of four types of scrambling seed values each having 9 bits for a PN9 scrambler corresponding to an existing scrambler index of 2 bits.

Referring to FIG. 7, the scrambler index of 2 bits shown in FIG. 6 corresponds to four scrambling seed values each having 9 bits. For example, a scrambling seed value when a value of the scrambler index is ‘00’ is ‘00010111’, a scrambling seed value when a value of the scrambler index is ‘10’ is ‘00011100’, a scrambling seed value when a value of the scrambler index is ‘01’ is ‘101110111’, and a scrambling seed value when a value of the scrambler index is ‘11’ is ‘101111100’.

As in the existing IEEE802.15.4g and the prior arts, the number of available scrambling seed values is four. In this case, only the predetermined four scrambling seed values must be repeatedly used although ten times of retransmission is necessary because a wireless environment is deteriorated. Option 1 that provides the highest data transfer rate of the MR-OFDM PHY header of the IEEE802.15.4g SUN is problematic in that the number of bits of the PHY header must be limited because at least 3 OFDM symbols are necessary to send a PHY header of 36 bits, such as that shown in FIG. 6.

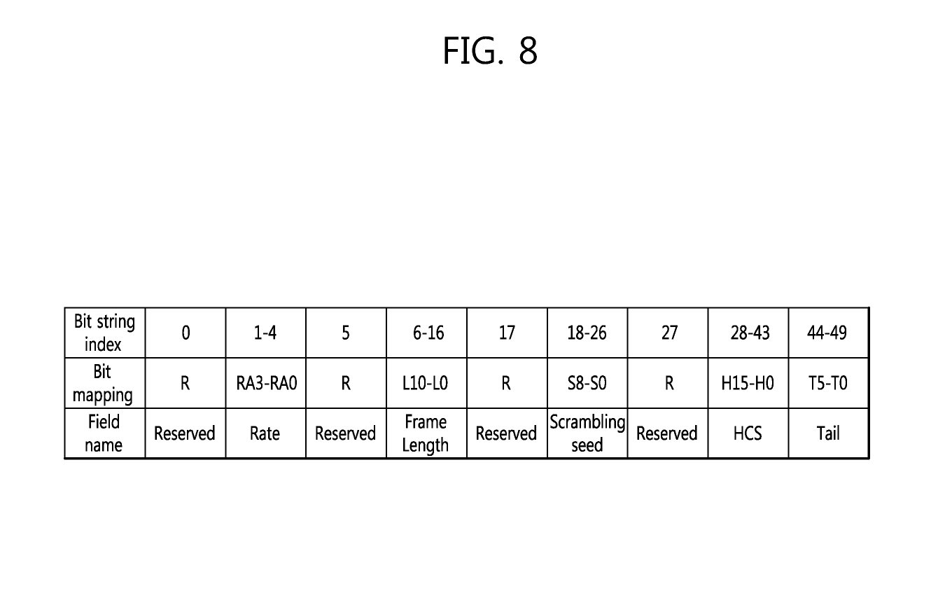

FIG. 8 shows the construction of a TVWS OFDM PHY header that includes a scrambling seed field regarding PN9. 9 bits are assigned (or allocated) for the scrambling seed filed in the FIG. 8. In this case, 2⁹ (ie. 512) numbers of scrambling seed values can be chosen freely.

value of 9 bits for PN9 in a PHY header in accordance with the present invention.

A data transfer rate for sending one OFDM symbol in the lowest data transfer rate mode of the TVWS OFDM PHY for sending the PHY header as described above is 50 bit. A scrambling seed capable of initializing a PN9 scrambler can be set within the PHY header using the amount of PHY header information as in FIG. 8. For example, the scrambling seed can be allocated to bit string indices 18 to 26. In this case, a problem in which a limited number of scrambling seeds according to a scrambler index is used can be solved, and a scrambling seed suitable for a TVWS WPAN wireless environment can be properly selected.

As described above, the present invention is advantageous in that the throughput of TVWS OFDM PHY that is being standardized in IEEE802.15.4m can be improved and a scrambling seed can be freely selected depending on a TVWS wireless environment.

The OFDM packet structure according to the present invention includes OFDM symbols that form an STF, that is, a preamble, OFDM symbols that form an LTF, an OFDM symbol that forms a PHY header, and OFDM symbols that transport a PHY payload, that is, real data, as in FIG. 3 or 5. In the OFDM packet structure according to the present invention, the number of OFDM symbols that form the STF can vary from 1 to 4. Furthermore, in an existing communication method, a scrambling seed value itself is not transmitted due to a limit to the number of data bits forming the PHY header, but a scrambling index that can be matched with a specific scrambling seed value is transmitted. In accordance with the present invention, however, in TVWS-OFDM, a scrambling seed value itself can be included in a scrambling seed field that forms the PHY header.

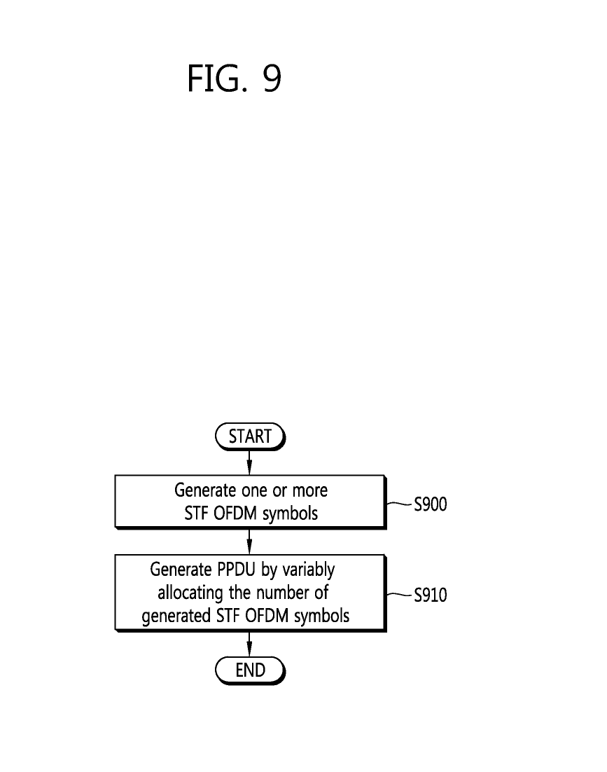

FIG. 9 is a flowchart illustrating a communication method using TVWS in accordance with an example of the present invention.

Referring to FIG. 9, the communication apparatus using TVWS (e.g., TVBD) in accordance with the present invention generates at least one STF OFDM symbol at step S900. The STF OFDM symbol forms the Short Training Field (STF) of WPAN OFDM PHY using TVWS. Here, each of the STF OFDM symbols can include 10 STF sequences, and each of the 10 STF sequences can include 16 samples. That is, each of the STF OFDM symbols can include 160 samples.

The communication apparatus using TVWS generates a PPDU by variably allocating the number of generated STF OFDM symbols at step S910. For example, the number of STF OFDM symbols allocated to the PPDU can be variably set from 1 to 4.

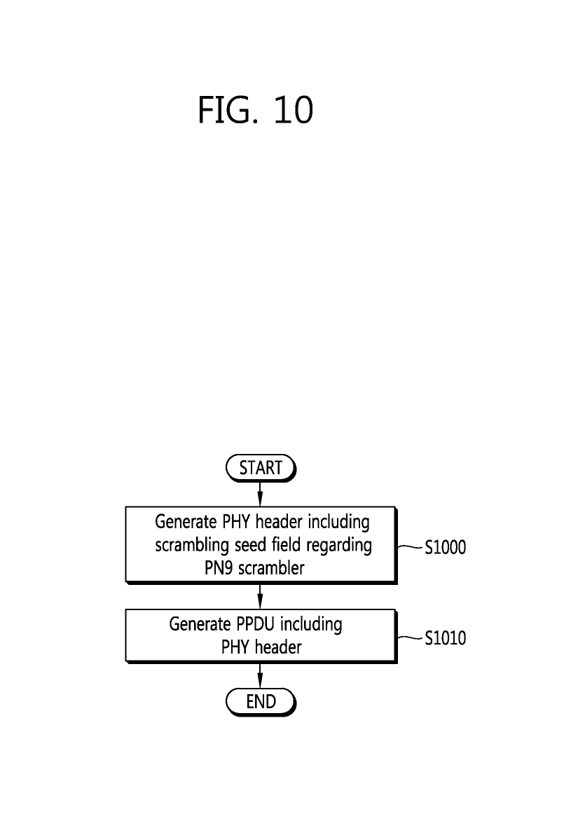

FIG. 10 is a flowchart illustrating a communication method using TVWS in accordance with another example of the present invention. The communication method of FIG. 10 can be applied to a WPAN system using TVWS.

The communication apparatus using TVWS in accordance with the present invention generates a PHY header which includes a scrambling seed field regarding to a PN9 scrambler at step S1000. For example, the scrambling seed field include scrambling seed values that can initialize the PN9 scrambler. The scrambling seed field can be configured with 9 bits size. In this case, for example, the bit string indices 18 to 26 of the PHY header can be allocated to the plurality of scrambling seeds can be assigned.

The PHY header can include one OFDM symbol based on the lowest data transfer rate mode in the TVWS OFDM PHY. That is, the PHY header can include 50 bits.

The PHY header can further include a Header Check Sequence (HCS) of 16 bits. The HCS can be based on a Cyclic Redundancy Check (CRC) code, such as that of the following equation.

G₁₆(x)=X¹⁶+X¹²+X⁵+1 [Equation 1]

The communication apparatus using TVWS generates a PPDU including the PHY header at step S1010.

Although the examples of the present invention have been separately illustrated in FIGS. 9 and 10, the procedures of FIGS. 9 and 10 may be performed together.

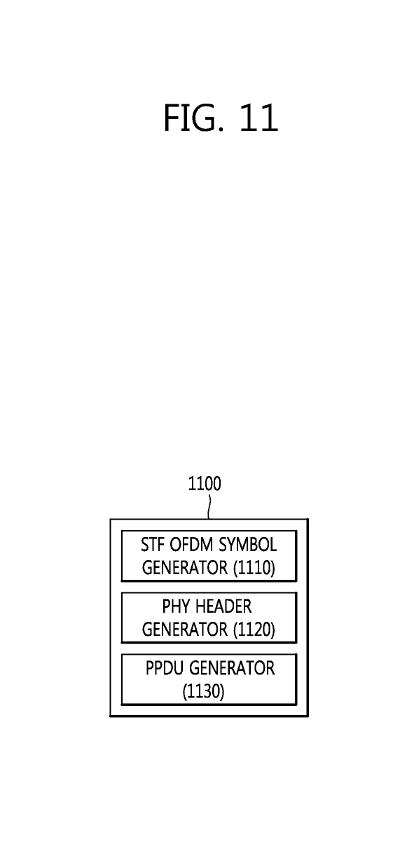

FIG. 11 is a block diagram of a communication apparatus 1100 using TVWS in accordance with the present invention.

Referring to FIG. 11, the communication apparatus 1100 using TVWS in accordance with the present invention includes a STF OFDM symbol generator 1110, a PHY header generator 1120, and a PPDU generator 1130.

The STF OFDM symbol generator 1110 generates one or more STF OFDM symbols. The STF OFDM symbol can form the STF of WPAN OFDM PHY using TVWS.

The STF OFDM symbol generator 1110 configures each of the STF OFDM symbols using 10 STF sequences and configure each of the 10 STF sequences using 16 samples. That is, the OFDM symbol generator 1110 can configure each of the STF OFDM symbols using 160 samples.

The PHY header generator 1120 generates a PHY header including a scrambling seed field regarding a PN9 scrambler. For example, the PHY header generator 1120 can generate the PHY header including the scrambling seed field including a scrambling seed value that capable of initializing the PN9 scrambler. For example, the PHY header generator 1120 can configure the scrambling seed field using, for example, 9 bits. Particularly, for example, the scrambling seed field can be allocated to bit string indices 18 to 26 of the PHY header. The scrambling seed field directly includes (or indicates) a scrambling seed value.

The PHY header generator 1120 can configure the PHY header using one OFDM symbol based on the lowest data transfer rate mode in TVWS OFDM PHY. That is, the PHY header generator 1120 can configure the PHY header having a size of 50 bits.

Furthermore, the PHY header generator 1120 can generate the PHY header further including an HCS of 16 bits. In this case, the HCS can be based on a CRC code, such as that shown in Equation 1.

The PPDU generator 1130 generates a PPDU by variably allocating the number of generated STF OFDM symbols to the PPDU. For example, the PPDU generator 1130 can generate the PPDU by variably allocating one to four STF OFDM symbols to the PPDU.

Furthermore, the PPDU generator 1130 generates the PPDU including the generated PHY header.

The PPDU generator 1130 can generate the PPDU including a PHY payload that conveys data to be transferred.

In accordance with the present invention, the throughput of an OFDM system can be improved by providing the TVWS OFDM PHY structure that supports efficient data transfer.

Furthermore, in accordance with the present invention, the wide selection of a scrambling seed can be guaranteed because a scrambling seed value is included in the PHY header depending on a TVWS wireless environment.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A communication method using TV White Spaces (TVWS), comprising:
generating one or more Short Training Field (STF) Orthogonal Frequency Division Multiplexing (OFDM) symbols that form an STF of Wireless Personal Area Network (WPAN) OFDM physical (PHY) using TVWS; and
generating a PLCP Protocol Data Unit (PPDU) by variably allocating a number of the generated STF OFDM symbols.

2. The method of claim 1, wherein the number of STF OFDM symbols allocated to the PPDU is variably set from 1 to 4.

3. The method of claim 2, wherein:
each of the STF OFDM symbols comprises 10 STF sequences, and
each of the 10 STF sequences comprises 16 samples.

4. The method of claim 2, wherein each of the STF OFDM symbols comprises 160 samples.

5. A communication apparatus using TVWS, comprising:
an OFDM symbol generator for generating one or more Short Training Field (STF) Orthogonal Frequency Division Multiplexing (OFDM) symbols that form an STF of Wireless Personal Area Network (WPAN) OFDM physical (PHY) using TVWS; and
a PPDU generator for generating a PLCP Protocol Data Unit (PPDU) by variably allocating a number of the generated STF OFDM symbols.

6. The communication apparatus of claim 5, wherein the PPDU generator generates the PPDU by variably allocating the number of STF OFDM symbols from 1 to 4.

7. The communication apparatus of claim 5, wherein the OFDM generator configures each of the STF OFDM symbols using 10 STF sequences and configures each of the 10 STF sequences using 16 samples.

8. The communication apparatus of claim 5, wherein the OFDM generator configures each of the STF OFDM symbols using 160 samples.

9. A communication method using TV White Spaces (TVWS) in a Wireless Personal Area Network (WPAN) system using TVWS, the communication method comprising:
generating a physical (PHY) header comprising a scrambling seed field regarding a Pseudo Noise (PN) 9 scrambler; and
generating a PLCP Protocol Data Unit (PPDU) comprising the PHY header.

10. The communication method of claim 9, wherein the scrambling seed field includes a scrambling seed value capable of initializing the PN9 scrambler.

11. The communication method of claim 10, wherein the scrambling seed field is configured using 9 bits.

12. The communication method of claim 11, wherein the PHY header comprises 50 bits.

13. The communication method of claim 11, wherein the PHY header comprises one OFDM symbol based on a lowest data transfer rate mode in TVWS OFDM PHY.

14. A communication apparatus using TVWS, comprising:
a PHY header generator for generating a PHY header comprising scrambling seed field regarding a PN 9 scrambler; and
a PPDU generator for generating a PLCP PPDU comprising the PHY header.

15. The communication apparatus of claim 14, wherein the PHY header generator generates the PHY header comprising the scrambling seed field including a scrambling seed value capable of initializing the PN9 scrambler.

16. The communication apparatus of claim 15, wherein the PHY header generator allocates 9 bits to the scrambling seed field.

17. The communication apparatus of claim 16, wherein the PHY header generator configures the PHY header having a size of 50 bits.

18. The communication apparatus of claim 16, wherein the PHY header generator configures the PHY header using one OFDM symbol based on a lowest data transfer rate mode in TVWS OFDM PHY.
